(19) United States
(12) Patent Application Publication
(10) Pub. No.: US 2008/0019819 A1
(43) Pub. Date: Jan. 24, 2008

(54) Palletizer apparatus and method

(76) Inventor: Lorin Reed, Kingsburg, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/880,387

(22) Filed: Jul. 19, 2007

Related U.S. Application Data
(60) Provisional application No. 60/807,778, filed on Jul. 19, 2006.

(51) Int. Cl. B65G 57/22

(52) U.S. Cl. 414/791.6; 414/802

(57) ABSTRACT

A palletizer for quickly and efficiently stacking a plurality of articles on a pallet by forming a stack of articles from the bottom of the stack. The palletizer comprises an article receiving section that forms articles into rows and moves the rows onto a platform, moveably disposed in a stack forming section, to form a layer of articles. A clamping mechanism in the stack forming section selectively clamps onto one or more layers to suspend a stack above the platform. A moving mechanism moves the platform between its lowered and raised positions. The platform has a conveyor to receive rows and transfer away loaded pallets. A conveyor moves pallets onto the platform. Another conveyor moves the loaded pallet away. The platform raises layers to form the stack from the bottom, with previous layers suspended by the clamping mechanism, and then raises the pallet to form the loaded pallet.

### CROSS-REFERENCE TO RELATED APPLICATIONS

This application claims the benefit of U.S. Provisional Patent Application No. 60/807,778 filed Jul. 19, 2006.

### BACKGROUND OF THE INVENTION

A. Field of the Invention

The field of the present invention relates generally to apparatuses and methods for stacking articles on a pallet or other load bearing structure. More particularly, the present invention relates to such apparatuses and methods that are configured to stack or palletize articles onto a pallet by forming the articles into layers, stacking subsequent layers underneath previous layers to form a stack and then placing the stack on the pallet.

B. Background

A wide variety of articles are stacked on pallets or other load bearing structures in warehouses, processing plants, stores or like facilities to facilitate storage, distribution and/or further processing of the articles. For purposes herein, the term pallet is utilized to refer to any load bearing structure that is suitable for supporting and carrying a load of articles, typically in a stack, thereon for storage and/or shipping of the articles. The standard pallet used in the shipping industry has an upper support surface on which the articles are stacked, a lower surface that rests on the ground or on another surface, and a gap between the upper and lower surface for receiving the tines of a forklift or like utility apparatus. The tines of the forklift are inserted in the gap to raise the pallet off of the ground and transport it to another location for storage, processing or transfer of the articles thereon. For ease of shipping and handling, various standard sizes and configurations for pallets are well known. The process of stacking articles on the pallet is commonly referred to as palletizing and the process of removing the articles from the pallet is commonly referred to as depalletizing. The terms palletizing and depalletizing refers generally to any stacking or unstacking process relative to articles that are placed on a pallet and the terms palletizer and depalletizer refers generally to apparatuses for performing such processes.

The articles placed, stored and/or delivered on a pallet typically comprise packaged goods, such as products stored in cartons or other types of packaging containers, or empty containers for goods, such as crates and the like that receive goods therein. For efficiency purposes, the articles are usually stacked on the pallet in layers of such articles, typically with a plurality of articles making up each layer. An example of the use of a pallet system to receive articles for storage, deliver or handling is the stacking of plastic crates on a pallet for use by a fruit or vegetable packing facility to fill with produce. The stack of crates placed on the pallet generally comprises a plurality of layers with each layer comprising a plurality of similarly sized and configured crates. After the stack of empty crates are delivered to the packing facility, the crates are removed from the pallet and distributed in the packing facility, where they are filled with fresh produce. The full crates are then re-stacked on a pallet for subsequent delivery to stores or other distribution centers. Typically, the crates are removed from (i.e., depalletized) and stacked on (i.e., palletized) on the pallet by hand, which requires a significant amount of labor and generally increases the risk that the crates will be damaged or that someone will be hurt during the palletizing or depalletizing processes.

To speed up the palletizing and depalletizing processes and reduce the chances of damage or injury, various automated machines have been developed to remove the articles from the pallet without requiring human labor. As an example, U.S. Pat. No. 4,214,848 to Verwey discloses a palletizer that comprises a loading conveyor which feeds a layer of articles to a transfer station on a vertical conveyor for transfer to a delivery station where the layer of articles are stacked on top of a pallet or a previously placed layer of articles positioned on the platform of a downstacker. U.S. Pat. No. 4,516,900 to Avey discloses a depalletizer that unloads articles from a pallet by tilting the pallet with a tilting mechanism so that the articles may be pushed off on to a discharge table by a pusher plate that has a protruding bar which engages the lower portion of the articles. U.S. Pat. No. 5,788,461 to Easton, et al. discloses an automatic depalletizer comprising a tilt bed which tilts a loaded pallet at a predetermined angle, a lift bed to raise the loaded pallet to the level of an exit conveyor, a back dam to exert a stop against a layer of articles to be removed and an endless collector belt to remove the entire layer of articles by applying a loading force against the articles. U.S. Pat. No. 5,971,700 to Heston discloses a pick and place palletizer/depalletizer having a lift head that is moved to engage a layer of articles located at a staging site and then place the layer on the pallet or on top of a previously placed layer or to engage a top layer on the pallet and then move that layer to a staging site. In one embodiment, the lift head is a vacuum lift head that comprises a plurality of orifices connected to a vacuum motor to engage the layer of articles by suction. U.S. Pat. No. 6,802,688 to Andersen, et al. discloses an apparatus for handling layers of palletized articles, both palletizing and depalletizing operations, that comprises a vertically displaceable lift head having a substantially horizontal suction face comprising a plurality of downwardly open suction chambers that engages the upper side of a stack of articles and either stacks them on a pallet, on top of a previously placed layer, or removes them from a pallet. The foregoing palletizers and depalletizers are examples of various types of apparatuses known in the art to stack articles on a pallet or remove articles from a pallet.

In general, many of the palletizer and depalletizer apparatuses presently available or in use are somewhat complex and are not configured to handle sufficiently large quantities of pallets and articles in both a cost and time efficient manner so as to be beneficially utilized by those in the industry. More specifically, with regard to palletizing operations what is needed is a palletizer that more effectively and efficiently stacks layers of articles on a pallet. The preferred palletizer should be configured to stack a pallet with a plurality of layers of articles in a process that more quickly and efficiently palletizes the pallet. Preferably, the palletizer should be configured to first form layers of articles, form a stack comprising a plurality of the layers of articles, place the stack of articles on a pallet and then transfer the palletized articles for storage, transport or further processing. The preferred depalletizer will be configured for a wide range of different types of articles and pallets.

### SUMMARY OF THE INVENTION

The palletizer apparatus and method of the present invention solves the problems and provides the benefits identified above. That is to say, the present invention discloses a palletizer that is configured to quickly and efficiently form articles into a layer of such articles, stack one or more layers of the articles on a pallet and then transfer the stacked pallet for storage, distribution or further processing. In a preferred embodiment of the palletizer apparatus of the present invention, the palletizer comprises an infeed conveyor that feeds articles to an article accumulator in a stack forming section, a raisable platform in the stack forming section that forms a stack by raising layers of articles to the bottom of the stack and then lowering the stack onto a pallet and a discharge conveyor that transfers away the stacked pallet. In a preferred embodiment of the process of the present invention, the palletizer receives a row of articles from an article infeed conveyor, forms a layer of such articles on a platform in the layer forming area, raises the layer up to a stack forming area, holds the layer in spaced apart relation to the platform, repeats the above to form other layers into the stack of articles, inserts a pallet onto the platform below the stack and then lowers the stack onto the pallet. The palletizer of the present invention is adaptable to a wide variety of pallets and articles.

In one general aspect of the present invention, the palletizer apparatus comprises an article receiving section that receives articles from a source of articles and forms the articles into rows of the desired length, a stack forming section having a moveable platform that moves up and down in a forming chamber, a pallet transfer section that transfers a pallet onto the platform and a load transfer section that transfers a loaded or palletized pallet for storage, distribution and/or further processing. The article receiving section has an article infeed conveyor that conveys the articles to an accumulation area where they are accumulated for forming into rows and a row feeding mechanism that transfers the rows to the platform inside the forming chamber. In a preferred embodiment, the row feeding mechanism comprises one or more pusher members configured to push the row of articles onto the platform. The rows of articles are formed into a layer of articles, comprising the desired number or rows, on the platform. The platform is part of a transfer mechanism associated with the stack forming section that comprises, in addition to the platform, a mechanism for moving the platform between its lowered and raised positions and a clamping mechanism for clamping one or more of the layers of articles. Preferably, the platform has a forming conveyor that receives the rows from the infeed conveyor and transfers the loaded pallet to the load transfer section. In a preferred embodiment, the moving mechanism comprises a pneumatic system that is operatively connected to the platform to selectively raise and lower the platform and the clamping mechanism comprises one or more clamp members that are configured to move between an open position and a clamping position that clamps one or more layers of articles. In one embodiment, clamp members are attached to doors located between the exit of the forming chamber and the conveyor to the load transfer section. When closed, the doors support the clamp members or act as clamp members themselves on one side of the forming chamber that, in cooperation with clamp members on the other sides, securely hold one or more layers of articles and support one or more layers above the clamped layers. The pallet transfer section has a pallet conveyor that transfers an empty pallet to the platform for palletizing and the load transfer section has a discharge conveyor for transferring the loaded pallet away from the forming chamber.

In operation, the infeed conveyor conveys a plurality of articles to the accumulation area where they are formed into a row and a row feeding mechanism transfers the row onto the platform in its lowered position. When a first layer of articles, made up of one or more rows, is on the platform, the moving mechanism operates to move the platform and first layer of articles upward to the raised position. The clamping mechanism is actuated to clamp against the first layer of articles and secure it in place above the platform, which is lowered back to its lowered position to receive a second layer of articles. The platform is then raised again to its raised position so the second layer of articles abuts the bottom of the first layer of articles. In one embodiment, the continued upward movement of the platform will push the second layer of articles between the clamping mechanisms until the clamping mechanism is clamped against the second layer, which is disposed below the first layer of articles. In another embodiment, the upward movement of the platform stops with the top of the second layer abutting the bottom of the first layer, the clamping mechanism releases the first layer onto the second layer (which is supported by the platform), the platform then moves upward to position the second layer at the clamping mechanism and the clamping mechanism clamps against the second layer, with the first layer supported above. In either configuration, once the second layer is clamped the platform moves downward to its lowered position and the process is repeated (i.e., new layer, raising, unclamping/clamping and lowering) as desired for third and subsequent layers, with the later layer replacing the second layer and the previous layer replacing the first layer in the process. Once the desired stack size is obtained, it is supported by the clamping mechanism and the platform moves down to its lowered position, a pallet is received on the platform, the pallet is raised to the bottom of the stack, the stack is released by the clamping mechanism onto the pallet to form the loaded pallet, the loaded pallet is lowered to its lowered position and then the loaded pallet is transferred to the load transfer section.

Accordingly, the primary objective of the present invention is to provide a palletizer apparatus and method that has the advantages discussed above and overcomes the disadvantages and limitations associated with presently available palletizers.

It is also an important object of the present invention to provide a palletizer apparatus and method that is configured to receive articles from an infeed conveyor and then form the articles into a layer of such articles for accumulation into a stack that is placed on a pallet for storage, distribution or further processing.

It is also an important object of the present invention to provide a depalletizer apparatus and method that comprises an article receiving section for receiving articles, a stack forming section for forming the articles into layers, forming the layers into a stack of articles, in an incremental manner, and then placing the stack of articles on a pallet, and a load transfer section for transferring the stacked pallet away.

It is also an important object of the present invention to provide a palletizer apparatus and method that palletizes a pallet with a stack of articles by incrementally raising layers of such articles up to a position below a previously formed layer of the articles to form a stack of articles and then lowering the stack onto a pallet.

It is also an important object of the present invention to provide a palletizer apparatus and method that comprises a stack forming section comprising a vertically moveable platform that moves layers upward to form a stack of such articles from the bottom thereof by clamping the stack above the next layer to be formed or above the pallet on which the stack is placed.

It is also an important object of the present invention to provide a palletizer method that palletizes a pallet with a stack of articles by receiving the articles from an infeed conveyor, moving a row of articles onto a platform, forming rows of the articles into layers on the platform, raising the layer of articles, clamping the layer of articles, lowering the platform to receive another row of articles thereon, repeating the forming, raising and lowering steps to form a stack of articles from the bottom, clamping the stack of articles at least at the lowest layer of articles to support that layer and any previously raised layer, inserting a pallet onto the platform, raising the pallet to support the stack of articles from the bottom thereof, releasing the clamping mechanism to place the load of articles on the pallet and then transporting away the stacked pallet.

It is also an object of the present invention to provide a palletizer apparatus that is adaptable to a wide range of different sizes of pallets and articles.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a palletizer configured according to a preferred embodiment of the present invention showing a row of articles in the article receiving section and the stack forming section and a loaded pallet in the load transfer section;

FIG. 2 is a side view of the palletizer of FIG. 1 showing a layer of articles supported by the platform in its raised position in the stack forming section and being squeezed by the clamping mechanism;

FIG. 3 is a side view of the palletizer of FIG. 2 showing a plurality of layers supported above the platform by the clamping mechanism with another layer on the platform in the lowered position;

FIG. 4 is a side view of the palletizer of FIG. 3 showing the platform in its raised position supporting a stack of articles thereon;

FIG. 5 is a side view of the palletizer of FIG. 4 showing the stack supported by the clamping mechanism and the platform moved to its lowered position with a pallet received in the stack forming section;

FIG. 6 is a side view of the palletizer of FIG. 5 showing the platform in its raised position supporting the pallet below the stack of articles and the stack released by the clamping mechanism onto the pallet;

FIG. 7 is a side view of the palletizer of FIG. 6 showing the platform moved to its lowered position with the loaded pallet thereon and ready for movement to the load transfer section;

FIG. 8 is a top view of the palletizer of the present invention showing articles moving through the article receiving section, a layer of articles in the stack forming section, a pallet ready to be moved to the stack forming section and a loaded pallet in the load transfer section;

FIG. 9 is a flow chart summarizing the steps of the palletizing process for the palletizer of the present invention; and

FIG. 10 is a flow chart summarizing the steps of an alternative palletizing process for the palletizer of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily described as being utilized with crates on a standard pallet, those skilled in the art will readily understand that this is merely for purposes of simplifying the present disclosure and that the present invention is not so limited, as the present invention is equally applicable for use with a variety of different types of articles and load bearing structures.

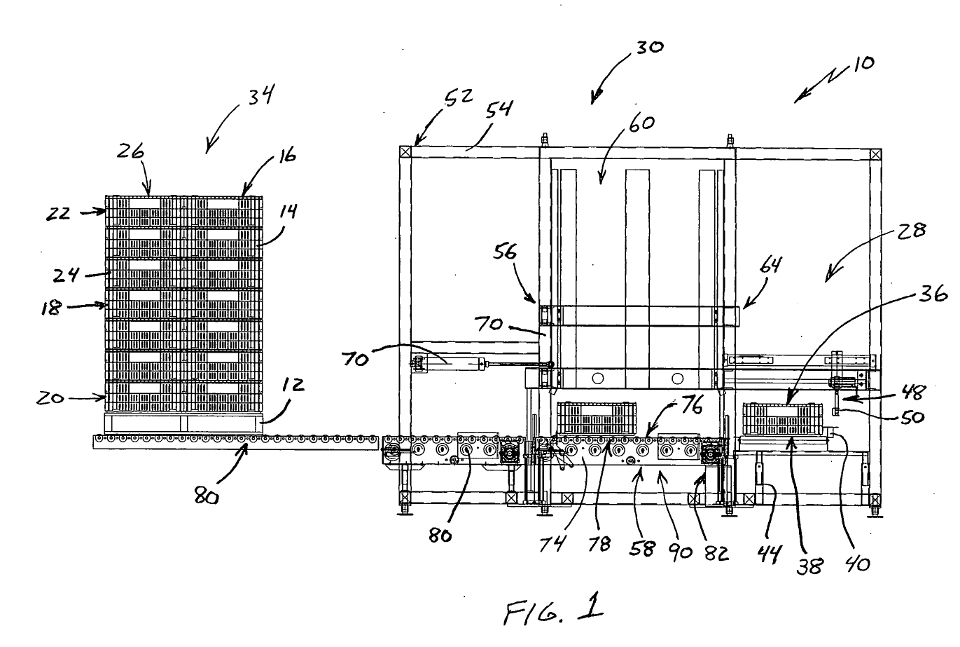

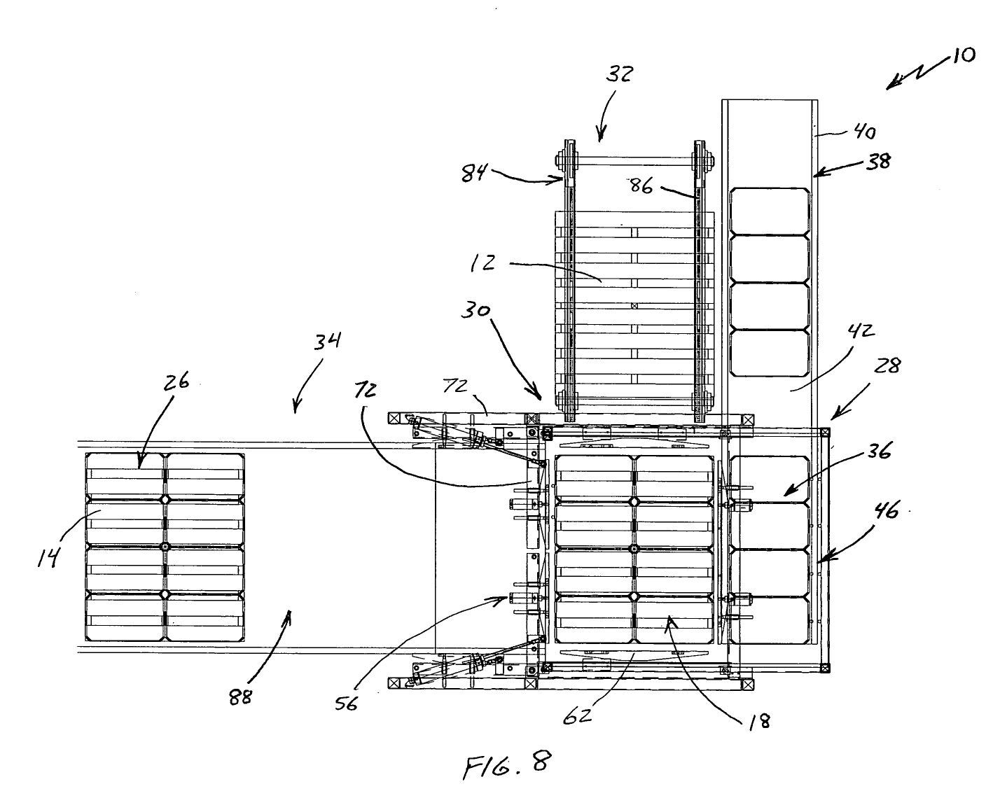

A palletizer apparatus that is manufactured out of the components and configured pursuant to a preferred embodiment of the present invention is shown generally as 10 in FIGS. 1 through 8. Palletizer 10 is configured to load a pallet 12 with a plurality of articles 14 configured as a stack 16 of such articles 14 having at least one layer 18. Typically, the stack 16 will have a plurality of layers 18 comprising a bottom layer 20, top layer 22 and a plurality of intermediate layers 24 therebetween. Collectively, the pallet 12 having a stack 16 of articles 14 thereon is referred to as a loaded pallet 26. As best shown in FIG. 8, palletizer 10 of the present invention generally comprises article receiving section 28 that receives and transfers individual articles 14, stack forming section 30 that forms layers 18, stack 16 and loaded pallet 26, a pallet transfer section 32 that transfers pallets 12 into stack forming section 30 and load transfer section 34 that transfers the loaded pallet 26 away from the palletizer 10. As will be explained in more detail below, articles 14 are received at the article receiving section 28 and transferred by rows 36 (as shown in FIG. 8) to stack forming section 30 where the rows 36 are formed into layers 18 and the layers 18 are formed into a stack 16, in a step-wise or incremental manner added to the bottom of the stack 16, that is placed onto pallet 12 to form loaded pallet 26.

Article receiving section 28 has an article infeed conveyor 38 comprising an infeed conveyor structure 40 supporting a conveyor mechanism, such as an endless belt conveyor having belt 42, as best shown in FIG. 8. Infeed conveyor structure 40 is supported in spaced apart relation above the floor of the facility or ground by one or more support legs 44. In the preferred embodiment, individual articles 14 are continuously fed into article infeed conveyor 38 to accumulate in a row 36 at the accumulation area 46 and the row 36 is directed into stack forming section 30. When a selected number of articles 14, such as the four shown in FIG. 8, are received in the accumulation area 46 alongside stack forming section 30 to form a row 36 of such articles 14, a row feeding mechanism 48 is activated to direct the row 36 of articles 14 into stack forming section 30 to form part of one of the layers 18 that makes up stack 16. In the embodiment shown, the row feeding mechanism 48 comprises a pusher member 50 that is configured to move the row 36 of articles 14 into stack forming section 30. In FIG. 8, the pusher member 50 is on an overhead continuous chain or like conveying mechanism that directs the pusher member 50 leftward against the articles 14 making up the row 36 and then pulls it back into position to be ready to push the articles 14 making up the next row 36. As shown in FIGS. 1 through 7, in a preferred embodiment pusher member 50 is downwardly extending when it pushes row 36 into layer forming section 30 and then folded upward, or otherwise positioned out of the way, as it moves back above articles 14 so as to not impede the movement of articles 14 along article infeed conveyor 38. Various electronic, mechanical or electro-mechanical mechanisms can be utilized with the palletizer 10 of the present invention to activate row feeding mechanism 48 to push a row 36 into stack forming section 30. In one embodiment, a switch located at the forward end of article infeed conveyor 38 is activated as a result of contact by the leading article 14 thereon (because they are continuously fed, when the leading article 14 hits the switch there will be a row 36 in the accumulation area 46). As will be readily apparent to those skilled in the art, various alternative article or other conveying mechanisms or pushing mechanisms can be utilized to transfer articles 14 to stack forming section 30. In addition, although a continuous feed conveying system is preferred to continually form rows 36 at the end of article infeed conveyor 38, if a non-continuous feed system is utilized it must be configured to accumulate a row 36 in accumulation area 46 prior to activating row feeding mechanism 48 to push row 36 into the stack forming section 30.

As shown in FIGS. 1 through 8, stack forming section 30 comprises a frame 52 having a plurality of frame members 54, a clamping mechanism 56 supported by the frame 52 and configured to clamp onto one or more layers 18 of stack 16 and support the layers 18 above the clamped layer(s), and a transfer mechanism 58, also supported by frame 52, configured to receive the rows 36 from the accumulation area 46 and the pallet 12 from the pallet transfer section 32 and to raise and lower the layers 18, pallet 12 and stack 16 to form loaded pallet 26. The frame members 52 of frame 50 define a forming chamber 60 in stack forming section 30 where the layers 18 are raised to form stack 16 (from the bottom) and then the pallet 12 is raised to the bottom of stack 16 to form loaded pallet 26.

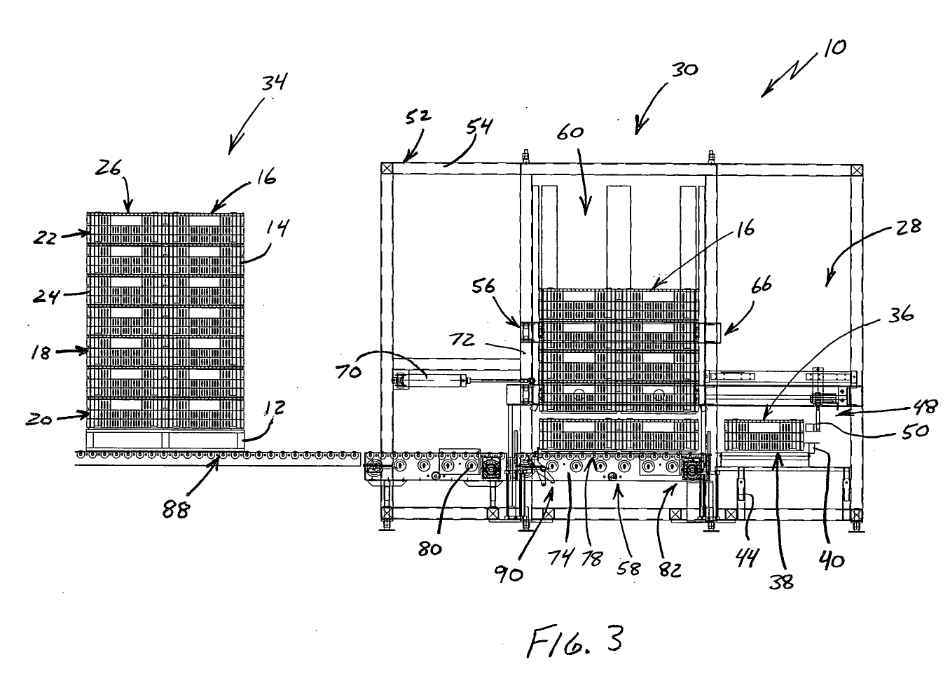

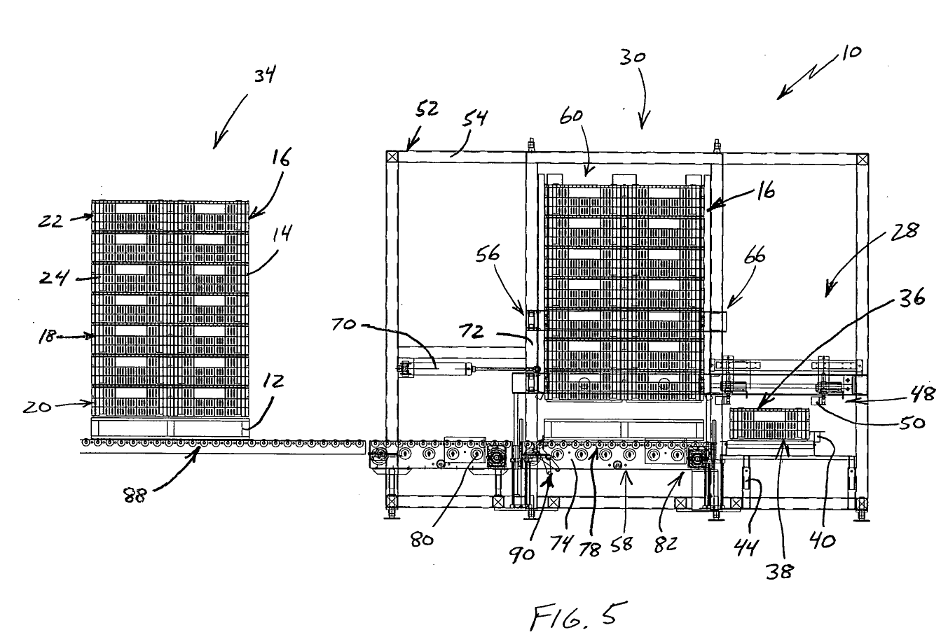

Clamping mechanism 56 is configured to clamp or squeeze against one or more layers 18 during the forming of stack 16 so as to hold stack 16 in a suspended position, such as shown in FIGS. 3 and 5. As such, clamping mechanism 56 must sufficiently clamp against layers 18 so that they do not fall when suspended, as explained below, during the forming of stack 16 or loaded pallet 26. As a result, palletizer 10 of the present invention can only be utilized with those articles 14 that have sufficient structural integrity to form a layer 18 which can be tightly clamped and which is strong enough to support the layers, such as the top 22 and intermediate 24 layers, above the clamped layer(s). For example, crates or other containers commonly utilized to store and transport fresh fruit and vegetables generally have the characteristics that make them particularly suitable for palletizer 10 of the present invention.

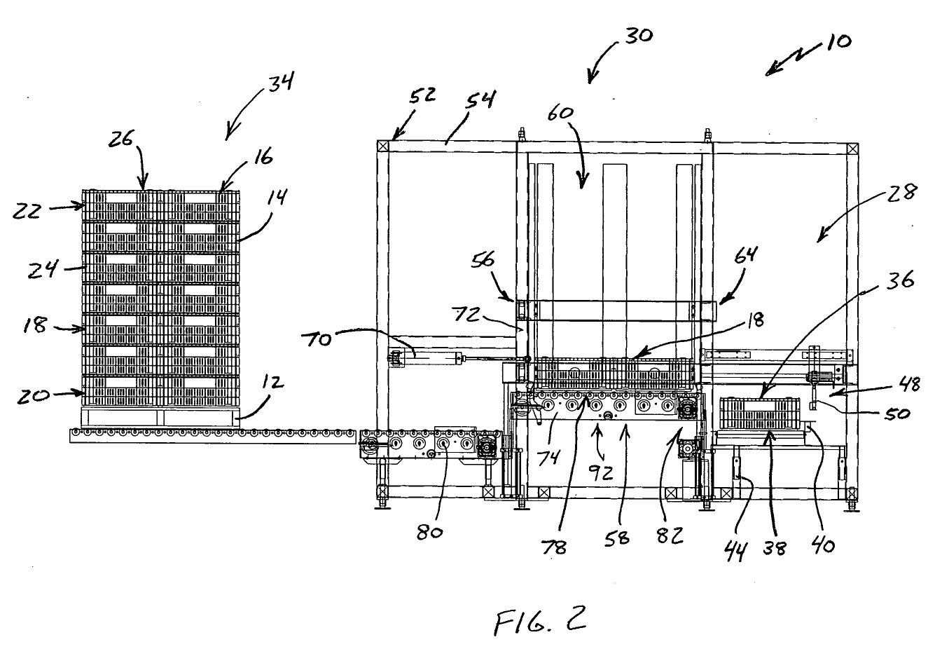

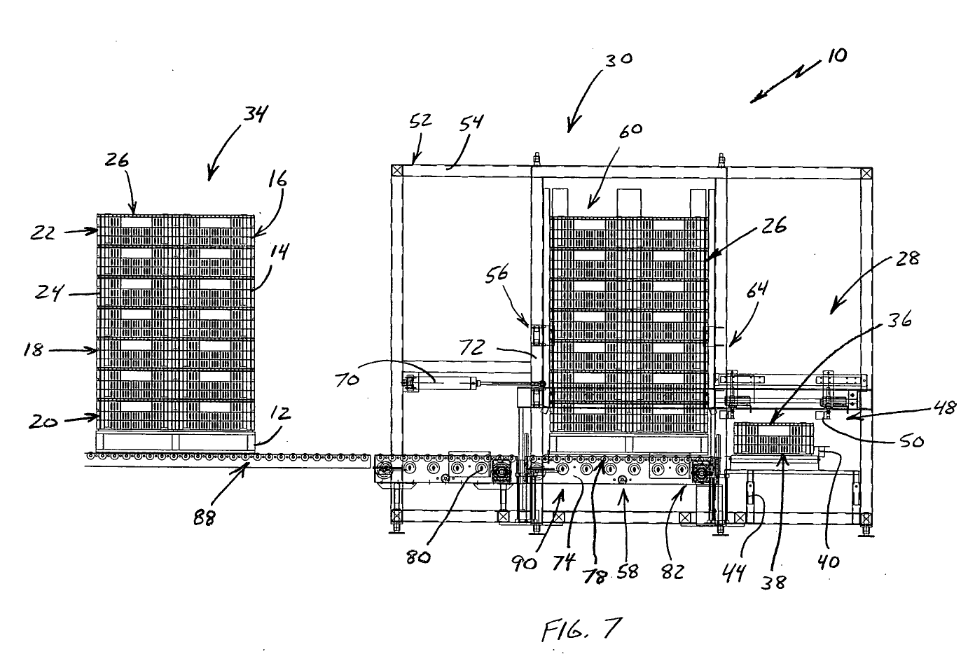

In a preferred embodiment, clamping mechanism 56 comprises a plurality of clamp members 62 operatively connected to clamp drive mechanism comprising a plurality of air cylinders and pneumatic valves that are configured to move clamp members 62 between their open position 64, as shown in FIGS. 1 and 7, and their closed or clamping position 66, as shown in FIGS. 3 and 5. As well known in the art, a variety of different electrical, mechanical, pneumatic and other systems can be utilized as the clamp drive mechanism for clamping mechanism 56. Clamping mechanism 56 is configured to clamp one or more layers 18 of stack 16, including at least the bottom layer 20. In the embodiment shown in the figures, the clamp members 62 of clamping mechanism 56 are configured to engage the bottom layer 20 and the second layer above the bottom layer 20, which are also referred to as the lower clamped layer, shown as 20 and the upper clamped layer 68, respectively. As explained in more detail below, because stack 16 is formed from the bottom, the first layer 18 that is received and held by the clamping mechanism 56, as shown in FIG. 2, will become top layer 22 of stack 16 and each of the subsequent layers 18 that are raised by transfer mechanism 58 will initially be the bottom layer 20 until the next layer 18 is raised, at which time the previous layer 18 will become an intermediate layer 24 until the last layer 18 of stack 16 is raised, which will be the bottom layer 20 of stack 16. Depending on the weight and structural integrity of the articles 14, it may only be necessary to clamp the bottom layer 20, if it is strong enough to support the above layers 18, or it may be necessary to clamp more than just two layers 18 in stack 16.

Clamping mechanism 56 can operate in a variety of different configurations. For instance, in one configuration clamp members 62 can be operated to uniformly squeeze against opposite sides of the lower clamped layer 20 and the upper clamped layer 66. In one preferred embodiment, however, the clamp members 56 on the right and top sides of the stack 16 (relative to the bottom of FIG. 8) are configured to move inwardly against stack 16 to square it up, thereby requiring these clamp members 62 to move only relatively small amount (i.e., one inch) to abut stack 16. In this embodiment, the clamp members 62 on the left and bottom sides of stack 16 move inwardly against stack 16 a distance sufficient to apply the desired amount of force to the one or more layers 18 to be clamped. The force imparted by these clamp members 62 (i.e., those on the left and bottom sides) is countered by the opposite clamp members 62 (i.e., those on the right and top sides) to engage one or more layers 18 of stack 16 therebetween. In another preferred embodiment, at least the clamp member 62 on the right side is fixed, with the other clamp members 62 operating to clamp a layer 18 against the fixed clamp member 62. As explained in more detail below, clamping mechanism 56 is operated to hold a layer 18 of articles 14 above the transfer mechanism 58 as another layer 18 is raised upward to be placed in abutting relation below the previously placed layer 18 to form stack 16 from the bottom and then, when the full stack 16 is formed, to hold the full stack 16 in position as the pallet 12 is raised upward to form stacked pallet 26.

Air cylinders 70 are utilized to open and close doors 72 at the exit of forming chamber 60 to the load transfer section 34, as best shown in FIG. 8. In the embodiment shown, doors 72 support the clamp members 62 on that side of the forming chamber 60 and are only opened to allow loaded pallet 26 to exit the forming chamber 60. In the embodiment shown, a pair of doors 72 are utilized, each supporting a clamp member 62 and associated valving. In a preferred embodiment, the doors 72 function as the clamp members 62 components of clamping mechanism 56 on the exit side of the forming chamber 60 of stack forming section 30. Doors 72 can be configured to abut against the side of a layer 18 and stack 16. In this embodiment, the clamp members 62 on the right side are configured to move in against the side of the lower clamped layer 20 and upper clamp layer 68 to squeeze the stack 16 therebetween. As explained in more detail below, the clamping mechanism 56 can be operated to alternatively open and close to squeeze or release the stack 16 in forming chamber 60 during the stack forming process. In a preferred embodiment, however, the clamping mechanism is configured to squeeze against the layer 18 or stack 16 and remain in its clamping position 66 as a new layer 18 is forced upward to slide into the clamped stack 16 and become the lower clamped layer 20 (until the next layer 18 is moved upward).

Transfer mechanism 58 is configured to receive rows 34 of articles 14 from the article infeed conveyor 38, raise the layer 18 upward to either begin or join (from the bottom) a stack 16, receive a pallet 12 from the pallet transfer section 32, raise the pallet 12 to the bottom of the stack 16 to form a loaded pallet 26 and then lower the loaded pallet 26 downward to move it to the load transfer section 34. In the preferred embodiment, transfer mechanism 58 comprises a platform 74 having a support surface 76 that supports the layers 18, pallet 12 and loaded pallet 26, and a forming conveyor 78 that is configured to receive the rows 36 from article infeed conveyor 38 and discharge the loaded pallet 12 to the load transfer section 34. In a preferred embodiment, as shown in the figures, the forming conveyor 78 is a roller conveyor. As explained in more detail below, platform 74 is moved up and down to either raise a layer 18 to the stack 16, so as to form the stack 16 from the bottom, or lower the stack 18 or loaded pallet 26 when formed. As well known in the art, the roller conveyor of forming conveyor 78 comprises a plurality of rollers 80 and associated motor(s) and drive assemblies to rotate rollers 80. To achieve the desired raising and lowering of platform 74, as described below, transfer mechanism 58 has a structure moving mechanism 82, such as a pneumatic system having one or more air cylinders that are configured to raise and lower platform 74 of transfer mechanism 58. The use of a pneumatic system to raise and lower a platform 74 is well know in the art.

Pallet transfer section 32, shown in FIG. 8, is utilized to transfer a pallet 12 onto platform 64 in the forming chamber 60 of stack forming section 30 after the stack 16 is formed, as shown in FIG. 5 (showing stack 16 held above platform 64 by clamping mechanism 56). Pallet transfer section 32 comprises a pallet conveyor 84 that moves pallet 12 onto platform 64. In the embodiment shown in FIG. 8, the pallet conveyor 84 is a belt conveyor having one or more belts 86 suitable for quickly and efficiently transferring pallet 12.

Load transfer section 34, shown in FIGS. 1 through 8, is utilized to receive a loaded pallet 26 from stack forming section 30 and transfer it away for storage, distribution and/or further processing. In a preferred embodiment, load transfer section 34 comprises a discharge conveyor 88 that is configured to receive loaded pallet 26 thereon. As with other conveyors in palletizer 10 of the present invention, discharge conveyor 88 can be a variety of different types of conveyors, including but not limited to a roller conveyor, chain conveyor, belt conveyor or strap conveyor.

The operation of the palletizer 10 of the present invention is shown sequentially in FIGS. 1 through 7. In FIG. 1, a row 36 has been transferred to the platform 74 in the forming chamber 60 and another row 36 is in the accumulation area 46 ready to be transferred to platform 74 by the downward projecting pusher member 50 of row feeding mechanism 48 to form a layer 18. Platform 74 is in its lowered position 90, as positioned by platform moving mechanism 82, which is substantially level with article infeed conveyor 38 and pallet conveyor 84. The doors 72, positioned by air cylinders 70, at the exit of forming chamber 60 are in their closed, clamping position and a completed loaded pallet 26 is on discharge conveyor 88 of load transfer section 34, ready for removal to storage, distribution and/or further processing. In FIG. 2, two rows 36 have formed a layer 18 that has been raised upward by platform 74, which is shown in its raised position 92, to be clamped by clamping mechanism 56. Pusher member 50 of row feeding mechanism 48 is folded upward and moved back to its start position, where it will be lowered and readied for moving the next row 36 onto platform 74. Once clamp members 62 are activated to clamp against layer 18, platform 74 will be moved by platform moving mechanism 82 back to its lowered position 90 to receive another row 36 to form another layer 18. The first layer 18 moved upward on platform 74 will be held in a suspended position above platform 74 by the clamp members 62 of clamping mechanism 56 to begin forming stack 16.

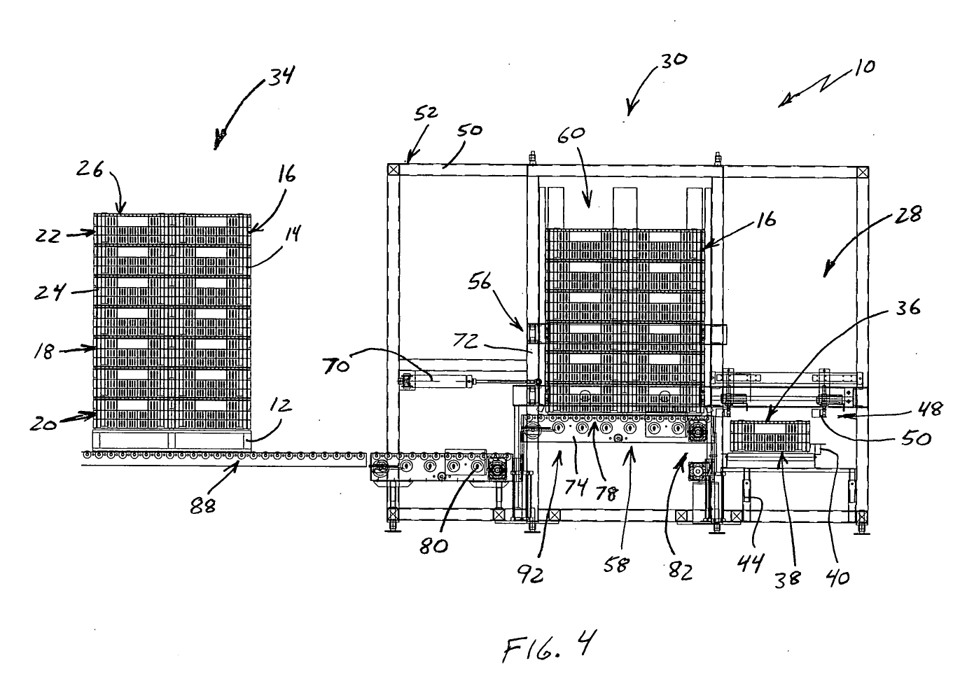

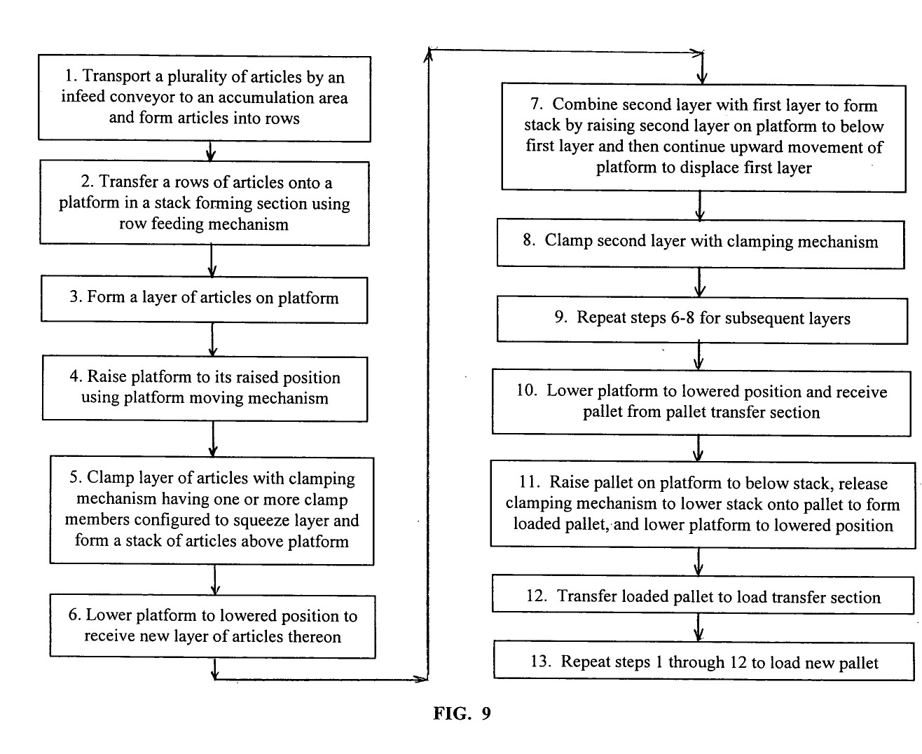

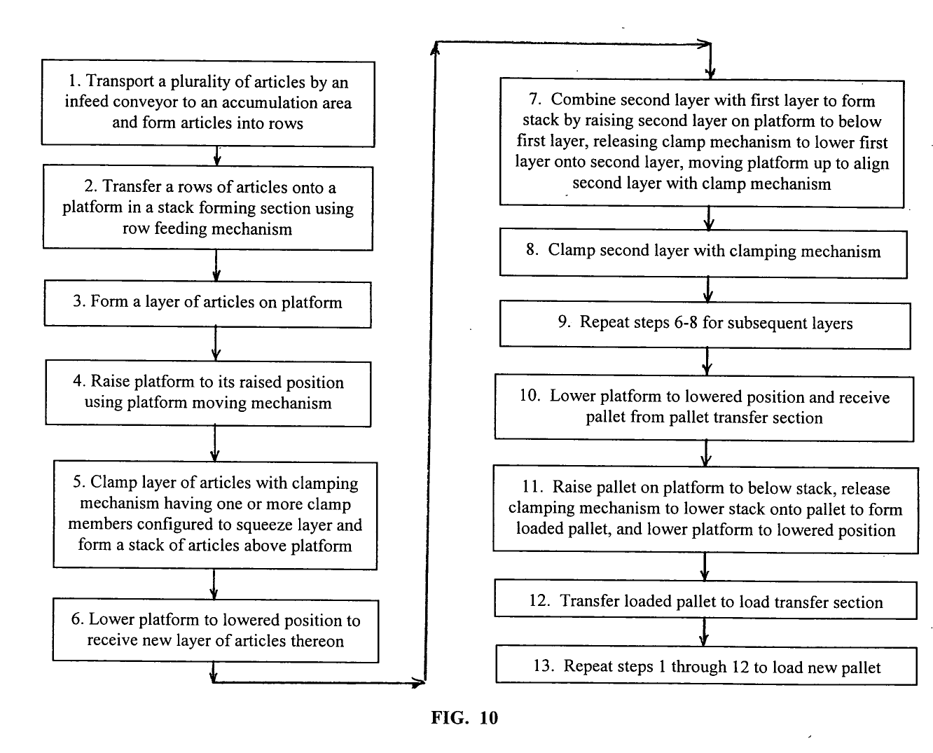

After the first layer 18 is formed and held in the suspended position by clamping mechanism 56 subsequent layers 18 are moved upward on platform 74 to form stack 16 from the bottom, resulting in the first layer 18 becoming the top layer 22 of the loaded pallet 26. FIG. 3 shows the partially completed stack 16 being supported by the clamp members 62 of clamping mechanism 56 above another layer 18 on platform 74, in its lowered position 90, that is ready to be lifted upward to join the stack 16 from the bottom, thereby pushing up the layers 18 that already form stack 16. FIG. 4 shows the layer 18 from FIG. 3 pushed up into the stack 16 as a result of the upward movement of platform 74, by platform moving mechanism 82 moving platform 74 to its raised position 92. Depending on the configuration of the articles 14 and clamping mechanism 56, the layer 18 can be moved up by pushing it through the clamp members 62 in their clamping position 66, summarized in the flow chart of FIG. 9, or by a process of alternating holding and releasing the stack 16, summarized in the flow chart of FIG. 10. In the former method, articles 14 and clamp members 62 are preferably configured with a smooth outer faces and the clamp members 62 should be made out of materials, such as stainless steel or the like, that facilitates the smooth faces of the articles 14 sliding upward while being clamped. The present inventor has found that this process works particularly well with empty plastic crates of the type that are utilized in the produce industry. Maintaining the clamping mechanism 56 in its clamping position 66 throughout the forming process for stack 16, only moving to the open position 64 to receive the first layer 18 and to release the full stack 16 onto the pallet 12 to form loaded pallet 26, increases the palletizing efficiency of palletizer 10 by speeding the formation of stack 16. In the method of alternating squeezing and releasing the stack 16, set forth in FIG. 10, the process requires raising platform 74 to place a layer 18 below the bottom layer 20 held by the clamping mechanism 56, releasing the previous held layer(s) 18 so the stack is lowered on top of the new layer 18 and supported by the platform 74 in its raised position 92, raising the platform 74 further to position the bottom layer 20 at the lower clamp members 62, clamping against at least the new bottom layer 20 to support the stack 16 above the platform 74, and then lowering the platform 74 to retrieve another layer 18 and repeat the above steps until the entire stack 16 is formed.

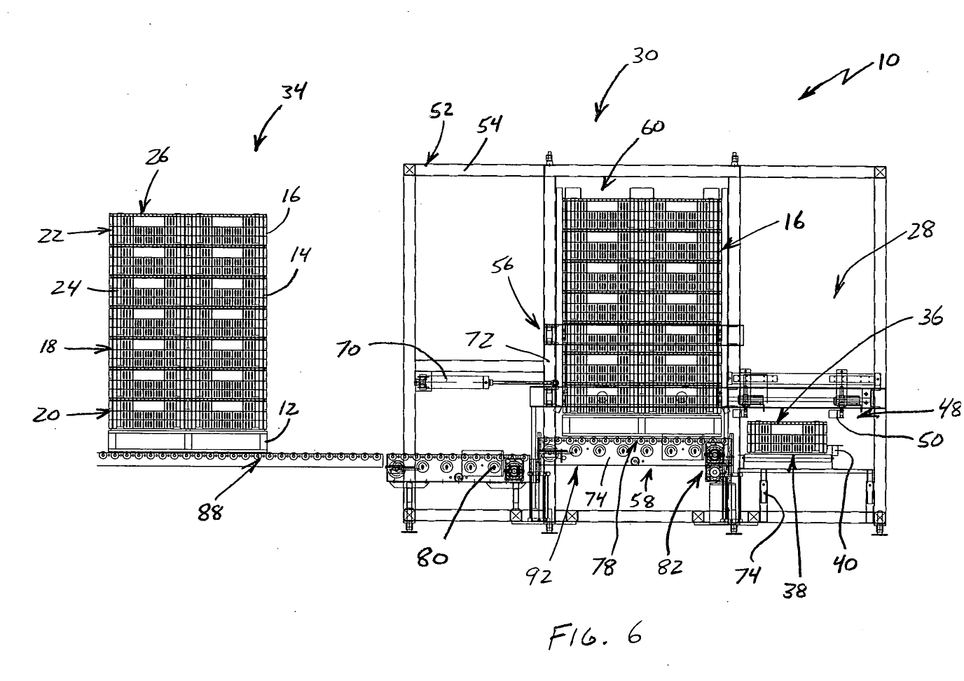

Once the stack 16 is formed in forming chamber 60 by receiving the last layer 18 of articles 14, which becomes bottom layer 20, a pallet 12 is moved into forming chamber 60, as shown in FIG. 5, by the pallet conveyor 84 of pallet transfer section 32. Initially, with pallet 12 on platform 74, the bottom layer 20 of stack 16 is in spaced apart relation to the support surface 76 of platform 74. FIG. 6 shows platform 74 moved upward to its raised position 92 by platform moving mechanism 82 to place the pallet 12 on platform 74 in abutting relation with the lower side of the bottom layer 20 of stack 16 in forming chamber 60. Clamping mechanism 56 is activated to release clamp members 62 so the weight of stack 16 is transferred to the pallet 12 supported on platform 74 to form loaded pallet 26. With the weight of loaded pallet 26 transferred to platform 74, the platform 74 is then lowered to its lowered position 90 so platform 74 is substantially level with pallet conveyor 84, as shown in FIG. 7, and the air cylinders 70 are activated to open doors 72. Once the platform 74 is at its lowered position 90 and the doors 72 are open, the forming conveyor 78 is activated to transfer the loaded pallet 26 to the pallet conveyor 84 for conveyance to the load transfer section 34, where loaded pallet 26 is ready for storage, distribution and/or further processing.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A palletizer for stacking a stack of articles on a pallet, said palletizer comprising:
a stack forming section having a platform configured to support a plurality of articles in a layer;
means associated with said platform for moving said platform between a lowered position to receive said plurality of articles or said pallet and a raised position to form said stack of articles and receive a loaded pallet; and
means associated with said stack forming section for clamping at least one layer of said stack of articles to define a clamped layer, said clamping means configured to support said stack of articles above said clamped layer, said clamping means further configured to receive said layer on said platform into said stack of articles from below said clamped layer.

2. The palletizer according to claim 1, wherein said clamping means comprises one or more clamp members configured to selectively move between an open position and a clamping position.

3. The palletizer according to claim 1, wherein said platform has a forming conveyor.

4. The palletizer according to claim 1, wherein said stack forming section further comprises a frame defining a forming chamber, said platform moveably disposed in said forming chamber.

5. The palletizer according to claim 4, wherein said moving means and said clamping means are disposed in said forming chamber.

6. The palletizer according to claim 1 further comprising an article receiving section configured to receive said plurality of articles, form said plurality of articles into a row of articles and transfer said row of articles to said platform.

7. The palletizer according to claim 6, wherein said article receiving section comprises a row feeding means for transferring said row of articles to said platform.

8. The palletizer according to claim 7, wherein said row feeding means comprises a pusher member configured to engage one or more articles in said row of articles so as to transfer said one or more articles to said platform.

9. The palletizer according to claim 1 further comprising a pallet transfer section having a pallet conveyor configured to transfer said pallet to said platform.

10. The palletizer according to claim 1 further comprising a load transfer section to transfer said loaded pallet from said stack forming section, said load transfer section having a discharge conveyor.

11. A palletizer for stacking a stack of articles on a pallet, said palletizer comprising:
an article receiving section configured to receive a plurality of articles and transfer said plurality of articles;
a stack forming section having a platform configured to support said plurality of articles in a layer;
a pallet transfer section configured to transfer said pallet to said platform;
means associated with said platform for moving said platform between a lowered position to receive said plurality of articles or said pallet and a raised position to form said stack of articles and receive a loaded pallet;
means associated with said stack forming section for clamping at least one layer of said stack of articles to define a clamped layer, said clamping means configured to support said stack of articles above said clamped layer, said clamping means further configured to receive said layer on said platform into said stack of articles from below said clamped layer; and
a load transfer section to transfer said loaded pallet from said stack forming section.

12. The palletizer according to claim 11, wherein said clamping means comprises one or more clamp members configured to selectively move between an open position and a clamping position.

13. The palletizer according to claim 11, wherein said platform has a forming conveyor.

14. The palletizer according to claim 11, wherein said article receiving section comprises a row feeding means for transferring a row of articles to said platform.

15. The palletizer according to claim 14, wherein said row feeding means comprises a pusher member configured to engage one or more articles in said row of articles so as to transfer said one or more articles to said platform.

16. A method of palletizing a plurality of articles into a stack of articles disposed on a pallet, said method comprising the steps of:
a. Raising a platform having a first layer of articles thereon, said platform moveably disposed in a stack forming section;
b. Clamping said first layer of articles with a means for clamping associated with said stack forming section to form said stack of articles;
c. Lowering said platform to a lowered position to receive a second layer of articles thereon;
d. Combining said second layer of articles with said stack of articles from below by raising said platform with said second layer of articles thereon to said raised position;
e. Clamping said second layer of articles with said clamping means;
f. Repeating steps c through e for subsequent layers of articles as desired;
g. Raising said pallet on said platform to below said stack of articles; and
h. Releasing said stack of articles onto said pallet to form a loaded pallet on said platform.

17. The method according to claim 16, wherein clamping means comprises one or more clamp members configured to move between an open position and a clamping position.

18. The method according to claim 16, wherein said combining step is accomplished with said clamping means in a clamping position.

19. The method according to claim 16, wherein said combining step is accomplished by raising said second layer of articles to below said stack of articles, placing said clamping means in an open position to release said stack of articles onto said second layer of articles, supporting said stack of articles on said second layer of articles and raising said platform to place said second layer of articles at said clamping means.

20. The method according to claim 16 further comprising the step of directing a row of articles onto said platform from an article receiving section prior to step a.
